(19) United States
(12) Patent Application Publication
(10) Pub. No.: US 2025/0153356 A1
(43) Pub. Date: May 15, 2025

(54) Systems and Methods For Robotic Map Annotations To Configure Customizable Behaviors

(71) Applicant: Brain Corporation, San Diego, CA (US)

(72) Inventor: David Ross, San Diego, CA (US)

(21) Appl. No.: 18/940,038

(22) Filed: Nov. 7, 2024

Related U.S. Application Data
(60) Provisional application No. 63/547,866, filed on Nov. 9, 2023.

(51) Int. Cl. B25J 9/16

(52) U.S. Cl. CPC B25J 9/1664; B25J 9/161; B25J 9/1697

(57) ABSTRACT

Systems and methods for robotic map annotations for customizing behaviors are disclosed herein. According to at least one non-limiting exemplary embodiment, robots produce computer readable maps of their environment which may be annotated to improve the functionality of the robots, configure tasks, and/or enable multimedia displays to enhance an environment. The highly customizable nature of the annotation system enables robots to rapidly adapt to the unique conditions of their environments.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems and methods for robotic map annotations to configure customizable behaviors.

### SUMMARY

The foregoing needs are satisfied by the present disclosure, which provides for, inter alia, systems and methods for robotic map annotations to configure customizable behaviors.

Exemplary embodiments described herein have innovative features, no single one of which is indispensable or solely responsible for their desirable attributes. Without limiting the scope of the claims, some of the advantageous features will now be summarized. One skilled in the art would appreciate that as used herein, the term robot may generally be referred to autonomous vehicle or object that travels a route, executes a task, or otherwise moves automatically upon executing or processing computer readable instructions.

According to at least one non-limiting exemplary embodiment, a system is disclosed. The system includes one or more robots and a server coupled to the one or more robots. The server includes one or more processors configured to execute computer readable instructions that cause the one or more processors to receive a query from a first device coupled to the server and associated with a first robot of the one or more robots, wherein the query comprises a request for one or more maps from a memory associated with the first robot and provide the map to the first device from the memory associated with the first robot; receive, from the first device, a set of user selected coordinates corresponding to an area on the map; associate the area with at least one media file via a first user input of the media file to the server; communicate the map, the area on the map, and the at least one media file to the first robot, wherein the first robot is configured to execute at least a portion of one or more of the at least one media file upon entering the area; and store the map, the user selected coordinates on the map, and the at least one media file corresponding to the area on the map in a memory of the server.

According to at least one non-limiting exemplary embodiment, one or more media files of the at least one media file comprise an interactive media program configured to prompt a user to provide a second user input to the first robot and execute a response to the second user input received by the first robot.

According to at least one non-limiting exemplary embodiment, the interactive media program comprises an item finding program, the second user input comprises a selection of one or more items, and the response to the second user input comprises at least one of (i) an indication of a location of the one or more items on the map and (ii) an instruction configured to cause the first robot to navigate to the location of the one or more items.

According to at least one non-limiting exemplary embodiment, the one or processors are further configured to execute the computer readable instructions to: receive a plurality of images from the one or more robots; identify one or more items within the images; and localize the one or more items on the map based at least in part upon a location on the map of where the images were taken and a location of the one or more items within one or more of the plurality of images.

According to at least one non-limiting exemplary embodiment, the at least one media file executed by the first robot comprises at least one of (i) an emission of a sound and (ii) a display of visual media, wherein a route navigated by the first robot is not modified by the execution of the one or more media files.

According to at least one non-limiting exemplary embodiment, the one or more processors are further configured to execute the computer readable instructions to receive a second query from the device or user interface of the robot, the second query includes a request for one or more items selected via the device or user interface; and provide an indication of the location for the selected one or more items via at least one of navigating to the location or displaying the computer readable map with the localization information corresponding to each of the selected one or more items.

According to at least one non-limiting exemplary embodiment, the first device is a user interface of the first robot of the one or more robots.

According to at least one non-limiting exemplary embodiment, the media file is provided by a second device different from the first device.

According to at least one non-limiting exemplary embodiment, the memory associated with the first robot is further associated with a first set of robots, the first set of robots comprising the first robot and at least a second robot, and the one or processors are further configured to execute the computer readable instructions to: transmit a signal to a first set of robots of the one or more robots, the first set of robots comprising the first robot and at least a second robot, the signal comprising a request for the map to be uploaded to the server from the memory of the first robot; and store the map in the memory of the server prior to providing the map to the first device associated with the first robot.

According to at least one non-limiting exemplary embodiment, a method for a server is disclosed. The method includes the steps of: receiving, by the server, a query from a first device coupled to the server and associated with a first robot, wherein the query comprises a request for a map from a first memory associated with the first robot; providing, by the server, the map to the first device from the first memory; receiving, by the server and from the first device, a set of user selected coordinates corresponding to an area on the map; associating, by the sever, the area with at least one media file via a first user input of the media file to the server; communicating the map, the area on the map, and the at least one media file to the first robot, wherein the first robot is configured to execute at least a portion of one or more of the at least one media file upon entering the area; and storing, by the server, the map, the user selected coordinates on the map, and the at least one media file corresponding to the area on the map in a second memory associated with the server.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a robot in accordance with some embodiments of this disclosure.

FIG. 1B is a functional block diagram of a controller or processor in accordance with some embodiments of this disclosure.

FIG. 1C is an exemplary rendering of a robot in accordance with some embodiments of this disclosure.

FIG. 2 is a functional block diagram of a server and robotic networks in accordance with some embodiments of this disclosure.

FIG. 3 depicts a neural network in accordance with some embodiments of this disclosure.

FIGS. 4A-C depict a top-down view of a computer readable map of an environment being produced and annotated, according to an exemplary embodiment.

FIG. 4D is a detailed view of an annotation and various annotation parameters configurable by a user, according to an exemplary embodiment.

FIG. 5A-C depicts a robot entering a region comprising a high-level annotation and performing an audio-visual display, according to an exemplary embodiment

FIG. 6 is a process flow diagram illustrating a method for file and data synchronization between one or more robots and a server, according to an exemplary embodiment.

FIG. 7 is a process flow diagram illustrating a method for annotating and updating computer readable maps for one or more robots via a server, according to an exemplary embodiment.

All Figures disclosed herein are © Copyright 2024 Brain Corporation. All rights reserved.

### DETAILED DESCRIPTION

Currently, robots cohabitate in many spaces with humans, such as warehouses, restaurants, supermarkets, parking lots, greeting areas, and the like. Many of these environments have overlapping needs for robots, for example item transport robots may be deployed in a restaurant to deliver food, in a warehouse to transport items, or in a supermarket to aide in restocking or assist disabled customers. Similarly, a hotel and a supermarket may desire to include a robot greeter which greets customers and potentially offers assistance if needed. However, one can appreciate how no two warehouses are identical, no warehouse is identical to a restaurant, no two restaurants are identical, and so forth. Accordingly, despite the tasks being very similar, situations where two robots in two separate locations following same behaviors are exceedingly rare. Accordingly, there is a need in the art to improve robotic adaptability for specific environmental needs while still enabling robots to be generic enough to autonomously perform in any appropriate environment.

Furthermore, within these populated environments, robots are often seen as an encumbrance to humans. As discussed above, robots are often working autonomously around humans, wherein a robot cleaning a floor in a supermarket would generally be perceived by the robots similar to an employee doing a job. Unlike human employees who can connect with customers on a humanitarian level, robots are often perceived as unconscious objects, wherein a robot blocking an aisle to clean the aisle is generally viewed as an encumbrance to the customer trying to get by. Accordingly, there is an additional need in the art to synergize generic robots into their environments in a customizable way such that robots may enhance their space and synergize with the environment beyond simple task performance.

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods for robotic map annotations to configure customizable behaviors. As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, SEGWAYS®, etc.), stocking machines, trailer movers, vehicles, and the like. Robots may also include any autonomous and/or semi-autonomous machine for transporting items, people, animals, cargo, freight, objects, luggage, and/or anything desirable from one location to another.

As used herein, a feature may comprise one or more numeric values (e.g., floating point, decimal, a tensor of values, etc.) characterizing an input from a sensor unit 114 including, but not limited to, detection of an object, parameters of the object (e.g., size, shape color, orientation, edges, etc.), color values of pixels of an image, depth values of pixels of a depth image, brightness of an image, the image as a whole, changes of features over time (e.g., velocity, trajectory, etc. of an object), sounds, spectral energy of a spectrum bandwidth, motor feedback (i.e., encoder values), sensor values (e.g., gyroscope, accelerometer, GPS, magnetometer, etc. readings), a binary categorical variable, an enumerated type, a character/string, or any other characteristic of a sensory input. Features may be defined at any level of abstraction. For example, a chair may be a feature of a dining area, room, or set; the chair may contain features such as cushions, legs, a back, and other features; the dining set may be a feature of a house; and the house may be a feature of a neighborhood, and so forth.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, 4G, or 5G including LTE/LTE-A/TD-LTE/TD-LTE, GSM, etc. variants thereof), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C #, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least, but not limited to: (i) expand the capabilities of existing robots without hardware modifications; (ii) provide highly-targeted location based advertisements; and (iii) provide thematic enhancements to an environment to benefit a customer experience. Other advantages are readily discernable by one of ordinary skill in the art given the contents of the present disclosure.

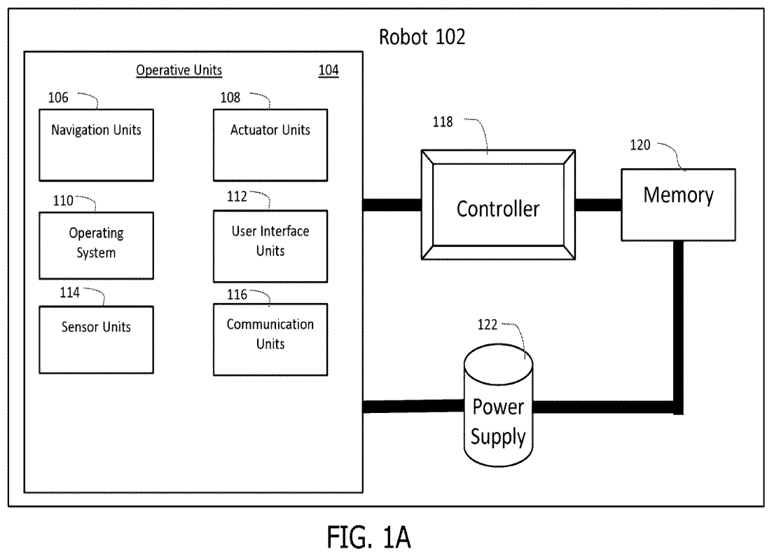

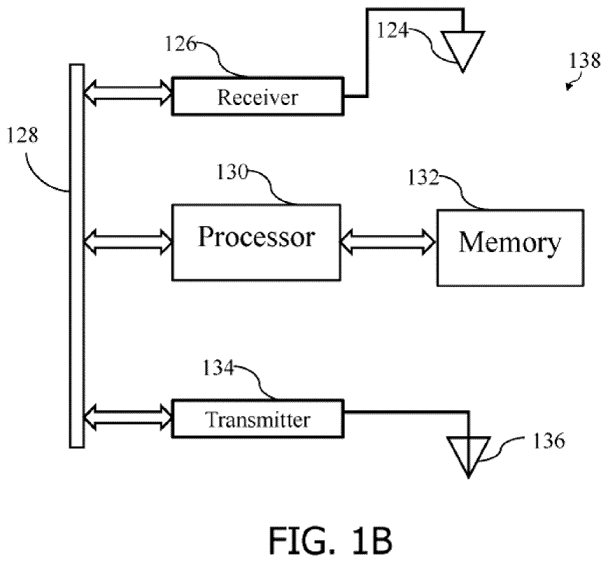

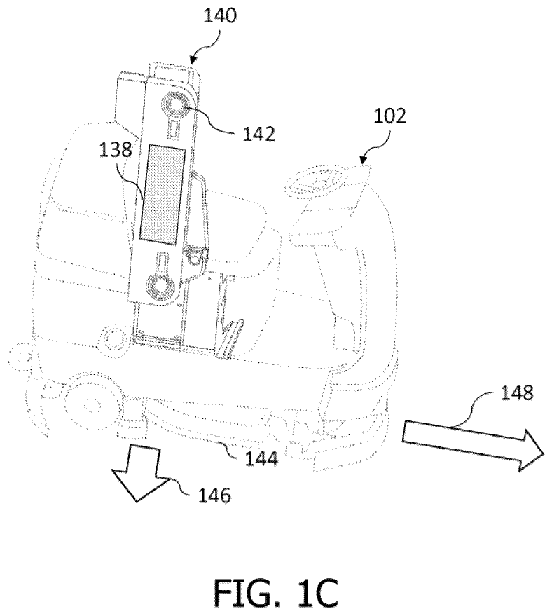

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processing devices (e.g., microprocessing devices) and other peripherals. As previously mentioned and used herein, processing device, microprocessing device, and/or digital processing device may include any type of digital processing device such as, without limitation, digital signal processing devices (“DSPs”), reduced instruction set computers (“RISC”), complex instruction set computers (“CISC”), microprocessing devices, gate arrays (e.g., field programmable gate arrays (“FPGAs”)), programmable logic device (“PLDs”), reconfigurable computer fabrics (“RCFs”), array processing devices, secure microprocessing devices and application-specific integrated circuits (“ASICs”). Peripherals may include hardware accelerators configured to perform a specific function using hardware elements such as, without limitation, encryption/description hardware, algebraic processing devices (e.g., tensor processing units, quadradic problem solvers, multipliers, etc.), data compressors, encoders, arithmetic logic units (“ALU”), and the like. Such digital processing devices may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide computer-readable instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the computer-readable instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processing device may be internal to or on board robot 102 and/or may be external to robot 102 and be communicatively coupled to controller 118 of robot 102 utilizing communication units 116 wherein the external processing device may receive data from robot 102, process the data, and transmit computer-readable instructions back to controller 118. In at least one non-limiting exemplary embodiment, the processing device may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processing devices. In some embodiments, a single controller (e.g., controller 118) may serve as the various controllers and/or processing devices described. In other embodiments different controllers and/or processing devices may be used, such as controllers and/or processing devices used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 includes at least navigation units 106, actuator units 108, user interface units 112, sensor units 114, and communication units 116. Operative units 104 may also comprise other units such as specifically configured task units (not shown) that provide the various functionality of robot 102. In exemplary embodiments, operative units 104 may be instantiated in software, hardware, or both software and hardware. For example, in some cases, units of operative units 104 may comprise computer implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magneto strictive elements, gesticulation, and/or any way of driving an actuator known in the art. By way of illustration, such actuators may actuate the wheels for robot 102 to navigate a route; navigate around obstacles; rotate cameras and sensors. According to exemplary embodiments, actuator unit 108 may include systems that allow movement of robot 102, such as motorize propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

Actuator unit 108 may also include any system used for actuating and, in some cases actuating task units to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“ToF”) cameras, structured light cameras, etc.), antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, arrays, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, sensor units 114 may be in part external to the robot 102 and coupled to communications units 116. For example, a security camera within an environment of a robot 102 may provide a controller 118 of the robot 102 with a video feed via wired or wireless communication channel(s). In some instances, sensor units 114 may include sensors configured to detect a presence of an object at a location such as, for example without limitation, a pressure or motion sensor may be disposed at a shopping cart storage location of a grocery store, wherein the controller 118 of the robot 102 may utilize data from the pressure or motion sensor to determine if the robot 102 should retrieve more shopping carts for customers.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3.5G, 3.75G, 3GPP/3GPP2/HSPA+), 4G (4GPP/4GPP2/LTE/LTE-TDD/LTE-FDD), 5G (5GPP/5GPP2), or 5G LTE (long-term evolution, and variants thereof including LTE-A, LTE-U, LTE-A Pro, etc.), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), Fire Wire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprising of numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processing device, or robot performing a task, operation or transformation illustrated in the figures below comprises a controller executing computer readable instructions stored on a non-transitory computer readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processing device 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132 which stores computer code or computer readable instructions in order for the processor 130 to execute the specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components—receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

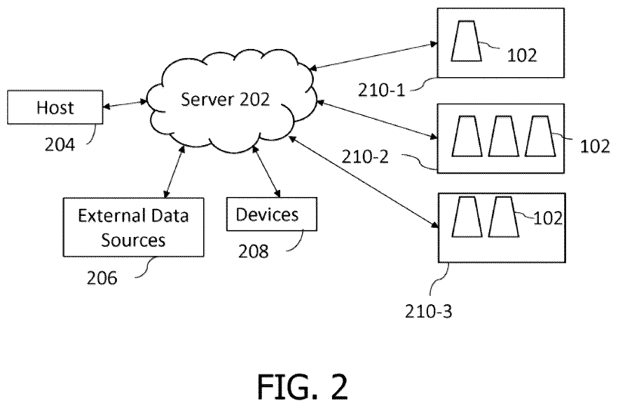

One of ordinary skill in the art would appreciate that the architecture illustrated in FIG. 1B may illustrate an external server architecture configurable to effectuate the control of a robotic apparatus from a remote location, such as server 202 illustrated next in FIG. 2. That is, the server may also include a data bus, a receiver, a transmitter, a processor, and a memory that stores specialized computer readable instructions thereon.

One of ordinary skill in the art would appreciate that a controller 118 of a robot 102 may include one or more processing devices 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices when instantiated in hardware are commonly used within the art to accelerate specific tasks (e.g., multiplication, encryption, etc.) which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer readable instructions to perform a function may include one or more processing devices 138 thereof executing computer readable instructions and, in some instances, the use of any hardware peripherals known within the art. Controller 118 may be illustrative of various processing devices 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processing devices 138 for performing high level tasks (e.g., planning a route to avoid obstacles) and processing devices 138 for performing low-level tasks (e.g., producing actuator signals in accordance with the route).

FIG. 1C is a three-dimensional rendition of a robot 102 configured to, at least in part, clean floors and capture images/video of a surrounding environment, according to an exemplary embodiment. The robot 102 shown in FIG. 1C is purely exemplary, wherein other robots 102 configured for other tasks and/or comprising different form factors are also considered. The robot 102 includes a scanning device 140, which comprises of vertically oriented cameras 142 that capture images off of a side of the robot 102 as it drives by, and cleaning equipment 144, which comprises one or more squeegees, brushes, vacuums, mops, and/or other floor care devices. The scanning device 140 enables what would be just a floor care robot 102 to also take images of the surrounding environment, wherein the images may be used to map the environment, identify features (e.g., detect certain products, people, or other things), or teleoperate the robot 102. This process of capturing images for use in identifying the depicted features is herein referred to as “scanning for features” or “feature scanning”. Processing the images to identify the features may occur on the robot 102 via controller 118 executing instructions or externally, e.g., via a server 202 described below. The features can be localized to a point on a map based upon: (i) the location of the robot 102 when the images are acquired, which is continuously and accurately tracked by navigation units 106, sensor units 114, and localization algorithms; and (ii) where these items are located in the image space. Once the image space location of the features and coordinate location of the image containing the features are determined, both locations may be utilized to determine the 3D location of the feature. The 3D location of the feature may be further based upon, for example, camera angle, a camera projection matrix, a depth of field analysis, data fusion from other robot 102 sensors such as LiDAR, and/or any distortion correction methods.

The scanning device 140 is configured in this embodiment to be modular, as shown by solid lines indicating detachable components. The device 140 further includes a screen 138, such as a liquid crystal display (“LCD”), light emitting diode (“LED”) display, projector, or other device with displays visual media. In some embodiments, as will be discussed below, the screen 138 is a touch screen or is otherwise capable of receiving user inputs (e.g., via tactile or virtual buttons). The scanning device 140 may further include speakers or devices configured to emit audio as output and/or receive audio as input. As will be discussed below, the screen and/or speakers will provide, inter alia, thematic enhancements to the environment which are highly customizable to user desires.

It is appreciated that use of a modular device 140 comprising the screen 138, speakers, and/or other devices for displaying audio and/or visual media is merely a non-limiting example which illustrates how an existing robot 102 can be adapted to be suitable for the present disclosure. In some cases, the default robot 102 (i.e., without any modules) may include sensors, a screen 138, and/or speakers. The present disclosure largely focuses on media displays from the robot 102, thus the robots 102 applicable to the present disclosure include some means for displaying media (e.g., speakers, screens, projectors, etc.) which may be a default feature of the robot 102 or one added via a modular attachment. Further, as explained herein via reference to a floor care robot 102, the default task of the robot 102 (e.g., cleaning floors) does not need to be related to the present disclosure for high-level annotations and media displays.

FIG. 2 illustrates a server 202 and communicatively coupled components thereof in accordance with some exemplary embodiments of this disclosure. The server 202 may comprise one or more processing units depicted in FIG. 1B above, each processing unit comprising at least one processor 130 and memory 132 therein in addition to, without limitation, any other components illustrated in FIG. 1B. The processing units may be centralized at a location or distributed among a plurality of devices (e.g., a cloud server). Communication links between the server 202 and coupled devices may comprise wireless and/or wired communications, wherein the server 202 may further comprise one or more coupled antenna to effectuate the wireless communication. The server 202 may be coupled to a host 204, wherein the host 204 may correspond to a high-level entity (e.g., an admin) of the server 202. The host 204 may, for example, upload software and/or firmware updates for the server 202 and/or coupled devices 208 and 210, connect or disconnect devices 208 and 210 to the server 202, or otherwise control operations of the server 202. External data sources 206 may comprise any publicly available data sources (e.g., public databases such as weather data from the national oceanic and atmospheric administration (NOAA), satellite topology data, public records, etc.) and/or any other databases (e.g., private databases with paid or restricted access) of which the server 202 may access data therein. Devices 208 may comprise any device configured to perform a task at an edge of the server 202. These devices may include, without limitation, internet of things (IoT) devices (e.g., stationary CCTV cameras, smart locks, smart thermostats, etc.), external processors (e.g., external CPUs or GPUs), and/or external memories configured to receive and execute a sequence of computer readable instructions, which may be provided at least in part by the server 202, and/or store large amounts of data.

Lastly, the server 202 may be coupled to a plurality of robot networks 210, each robot network 210 comprising a local network of at least one robot 102. Each separate network 210 may comprise one or more robots 102 operating within separate environments from each other. An environment may comprise, for example, a section of a building (e.g., a floor or room) or any space in which the robots 102 operate. Each robot network 210 may comprise a different number of robots 102 and/or may comprise different types of robot 102. For example, network 210-2 may comprise a scrubber robot 102, vacuum robot 102, and a gripper arm robot 102, whereas network 210-1 may only comprise a robotic wheelchair, wherein network 210-2 may operate within a retail store while network 210-1 may operate in a home of an owner of the robotic wheelchair or a hospital. Each robot network 210 may communicate data including, but not limited to, sensor data (e.g., RGB images captured, LiDAR scan points, network signal strength data from sensors 202, etc.), IMU data, navigation and route data (e.g., which routes were navigated), localization data of objects within each respective environment, and metadata associated with the sensor, IMU, navigation, and localization data. Each robot 102 within each network 210 may receive communication from the server 202 including, but not limited to, a command to navigate to a specified area, a command to perform a specified task, a request to collect a specified set of data, a sequence of computer readable instructions to be executed on respective controllers 118 of the robots 102, software updates, and/or firmware updates. One skilled in the art may appreciate that a server 202 may be further coupled to additional relays and/or routers to effectuate communication between the host 204, external data sources 206, edge devices 208, and robot networks 210 which have been omitted for clarity. It is further appreciated that a server 202 may not exist as a single hardware entity, rather may be illustrative of a distributed network of non-transitory memories and processors.

According to at least one non-limiting exemplary embodiment, each robot network 210 may comprise additional processing units as depicted in FIG. 1B above and act as a relay between individual robots 102 within each robot network 210 and the server 202. For example, each robot network 210 may represent a plurality of robots 102 coupled to a single Wi-Fi signal, wherein the robot network 210 may comprise in part a router or relay configurable to communicate data to and from the individual robots 102 and server 202. That is, each individual robot 102 is not limited to being directly coupled to the server 202 and devices 206, 208.

One skilled in the art may appreciate that any determination or calculation described herein may comprise one or more processors of the server 202, edge devices 208, and/or robots 102 of networks 210 performing the determination or calculation by executing computer readable instructions. The instructions may be executed by a processor of the server 202 and/or may be communicated to robot networks 210 and/or edge devices 208 for execution on their respective controllers/processors in part or in entirety (e.g., a robot 102 may calculate a coverage map using measurements 308 collected by itself or another robot 102). Advantageously, use of a centralized server 202 may enhance a speed at which parameters may be measured, analyzed, and/or calculated by executing the calculations (i.e., computer readable instructions) on a distributed network of processors on robots 102 and devices 208. Use of a distributed network of controllers 118 of robots 102 may further enhance functionality of the robots 102 as the robots 102 may execute instructions on their respective controllers 118 during times when the robots 102 are not in use by operators of the robots 102.

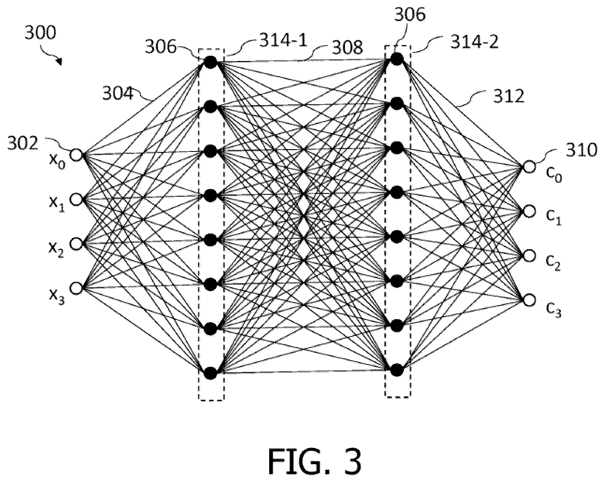

FIG. 3 illustrates a neural network 300, according to an exemplary embodiment. The neural network 300 may comprise a plurality of input nodes 302, intermediate nodes 306, and output nodes 310. The input nodes 302 being connected via links 304 to one or more intermediate nodes 306. Some intermediate nodes 306 may be respectively connected via links 308 to one or more adjacent intermediate nodes 306. Some intermediate nodes 306 may be connected via links 312 to output nodes 310. Links 304, 308, 312 illustrate inputs/outputs to/from the nodes 302, 306, and 310 in accordance with Equation 1 below. The intermediate nodes 306 may form an intermediate layer 314 of the neural network 300. In some embodiments, a neural network 300 may comprise a plurality of intermediate layers 314, intermediate nodes 306 of each intermediate layer 314 being linked to one or more intermediate nodes 306 of adjacent layers, unless an adjacent layer is an input layer (i.e., input nodes 302) or an output layer (i.e., output nodes 310). The two intermediate layers 314 illustrated may correspond to a hidden layer of neural network 300, however a hidden layer may comprise more or fewer intermediate layers 314 or intermediate nodes 306. Each node 302, 306, and 310 may be linked to any number of nodes, wherein linking all nodes together as illustrated is not intended to be limiting. For example, the input nodes 302 may be directly linked to one or more output nodes 310.

The input nodes 306 may receive a numeric value xᵢ of a sensory input of a feature, i being an integer index. For example, xᵢ may represent color values of an i^{th} pixel of a color image. The input nodes 306 may output the numeric value xᵢ to one or more intermediate nodes 306 via links 304. Each intermediate node 306 may be configured to receive a numeric value on its respective input link 304 and output another numeric value k_{i,j} to links 308 following the Equation 1 below:

$${k}_{i , j} = {a}_{i} , {}_{j} {x}_{0} + {b}_{i} , {}_{j} {x}_{1} + {c}_{i} , {}_{j} {x}_{2} + {d}_{i} , {}_{j} {x}_{3} \qquad ( Eqn . l )$$

Index i corresponds to a node number within a layer (e.g., x₁ denotes the first input node 302 of the input layer, indexing from zero). Index j corresponds to a layer, wherein j would be equal to one for the one intermediate layer 314-1 of the neural network 300 illustrated, however, j may be any number corresponding to a neural network 300 comprising any number of intermediate layers 314. Constants a, b, c, and d represent weights to be learned in accordance with a training process. The number of constants of Equation 1 may depend on a number of input links 304 to a respective intermediate node 306. In this embodiment, all intermediate nodes 306 are linked to all input nodes 302, however this is not intended to be limiting. Intermediate nodes 306 of the second (rightmost) intermediate layer 314-2 may output values k_{i,2} to respective links 312 following Equation 1 above. It is appreciated that constants a, b, c, d may be of different values for each intermediate node 306. Further, although the above Equation 1 utilizes addition of inputs multiplied by respective learned coefficients, other operations are applicable, such as convolution operations, thresholds for input values for producing an output, and/or biases, wherein the above equation is intended to be illustrative and non-limiting.

Output nodes 310 may be configured to receive at least one numeric value k_{i,j} from at least an i^{th} intermediate node 306 of a final (i.e., rightmost) intermediate layer 314. As illustrated, for example, each output node 310 receives numeric values k_{0-7,2} from the eight intermediate nodes 306 of the second intermediate layer 314-2. The output of the output nodes 310 may comprise a classification of a feature of the input nodes 302. The output ci of the output nodes 310 may be calculated following a substantially similar equation as Equation 1 above (i.e., based on learned weights and inputs from connections 312). Following the above example where inputs xᵢ comprise pixel color values of an RGB image, the output nodes 310 may output a classification ci of each input pixel (e.g., pixel i is a car, train, dog, person, background, soap, or any other classification). Other outputs of the output nodes 310 are considered, such as, for example, output nodes 310 predicting a temperature within an environment at a future time based on temperature measurements provided to input nodes 302 at prior times and/or at different locations.

The training process comprises providing the neural network 300 with both input and output pairs of values to the input nodes 302 and output nodes 310, respectively, such that weights of the intermediate nodes 306 may be determined. An input and output pair comprise a ground truth data input comprising values for the input nodes 302 and corresponding correct values for the output nodes 310 (e.g., an image and corresponding annotations or labels). The determined weights configure the neural network 300 to receive input at input nodes 302 and determine a correct output at the output nodes 310. By way of illustrative example, annotated (i.e., labeled) images may be utilized to train a neural network 300 to identify objects or features within the image based on the annotations and the image itself, the annotations may comprise, e.g., pixels encoded with “cat” or “not cat” information if the training is intended to configure the neural network 300 to identify cats within an image. The unannotated images of the training pairs (i.e., pixel RGB color values) may be provided to input nodes 302 and the annotations of the image (i.e., classifications for each pixel) may be provided to the output nodes 310, wherein weights of the intermediate nodes 306 may be adjusted such that the neural network 300 generates the annotations of the image based on the provided pixel color values to the input nodes 302. This process may be repeated using a substantial number of labeled images (e.g., hundreds or more) such that ideal weights of each intermediate node 306 may be determined. The training process is complete upon predictions made by the neural network 300 falling below a threshold error rate which may be defined using a cost function.

As used herein, a training pair may comprise any set of information provided to input and output of the neural network 300 for use in training the neural network 300. For example, a training pair may comprise an image and one or more labels of the image (e.g., an image depicting a cat and a bounding box associated with a region occupied by the cat within the image).

Neural network 300 may be configured to receive any set of numeric values representative of any feature and provide an output set of numeric values representative of the feature. For example, the inputs may comprise color values of a color image and outputs may comprise classifications for each pixel of the image. As another example, inputs may comprise numeric values for a time dependent trend of a parameter (e.g., temperature fluctuations within a building measured by a sensor) and output nodes 310 may provide a predicted value for the parameter at a future time based on the observed trends, wherein the trends may be utilized to train the neural network 300. Training of the neural network 300 may comprise providing the neural network 300 with a sufficiently large number of training input/output pairs comprising ground truth (i.e., highly accurate) training data. As a third example, audio information may be provided to input nodes 302 and a meaning of the audio information may be provided to output nodes 310 to train the neural network 300 to identify words and speech patterns.

Generation of the sufficiently large number of input/output training pairs may be difficult and/or costly to produce. Accordingly, most contemporary neural networks 300 are configured to perform a certain task (e.g., classify a certain type of object within an image) based on training pairs provided, wherein the neural networks 300 may fail at other tasks due to a lack of sufficient training data and other computational factors (e.g., processing power). For example, a neural network 300 may be trained to identify cereal boxes within images, however the same neural network 300 may fail to identify soap bars within the images.

As used herein, a model may comprise of the weights of intermediate nodes 306 and output nodes 310 learned during a training process. The model may be analogous to a neural network 300 with fixed weights (e.g., constants a, b, c, d of Equation 1), wherein the values of the fixed weights are learned during the training process. A trained model, as used herein, may include any mathematical model derived based on a training of a neural network 300. One skilled in the art may appreciate that utilizing a model from a trained neural network 300 to perform a function (e.g., identify a feature within sensor data from a robot 102) utilizes significantly less computational recourses than training of the neural network 300 as the values of the weights are fixed. This is analogous to using a predetermined equation to solve a problem as compared to determining the equation itself based on a set of inputs and results.

According to at least one non-limiting exemplary embodiment, one or more outputs k_{i,j} from intermediate nodes 306 of a j^{th} intermediate layer 312 may be utilized as inputs to one or more intermediate nodes 306 an m^{th} intermediate layer 312, wherein index m may be greater than or less than j (e.g., a recurrent or feed forward neural network). According to at least one non-limiting exemplary embodiment, a neural network 300 may comprise N dimensions for an N dimensional feature (e.g., a 3-dimensional input image or point cloud), wherein only one dimension has been illustrated for clarity. One skilled in the art will appreciate a plurality of other embodiments of a neural network 300, wherein the neural network 300 illustrated represents a simplified embodiment of a neural network to illustrate the structure, utility, and training of neural networks that is not intended to be limiting. The exact configuration of the neural network used may depend on factors such as: (i) processing resources available, (ii) training data available, (iii) quality of the training data, and/or (iv) difficulty or complexity of the classification/problem. Further, programs such as AutoKeras, utilize automatic machine learning (“AutoML”) to enable one of ordinary skill in the art to optimize a neural network 300 design to a specified task or data set.

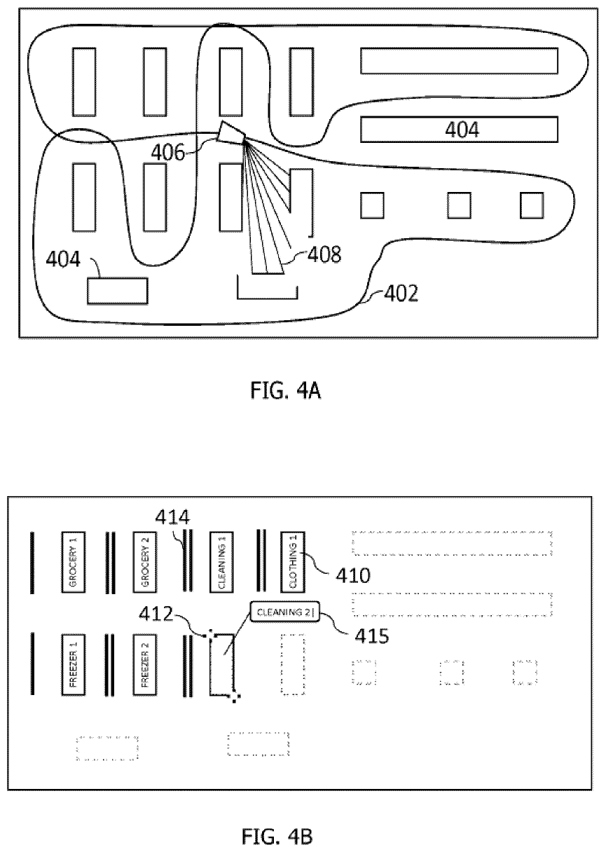

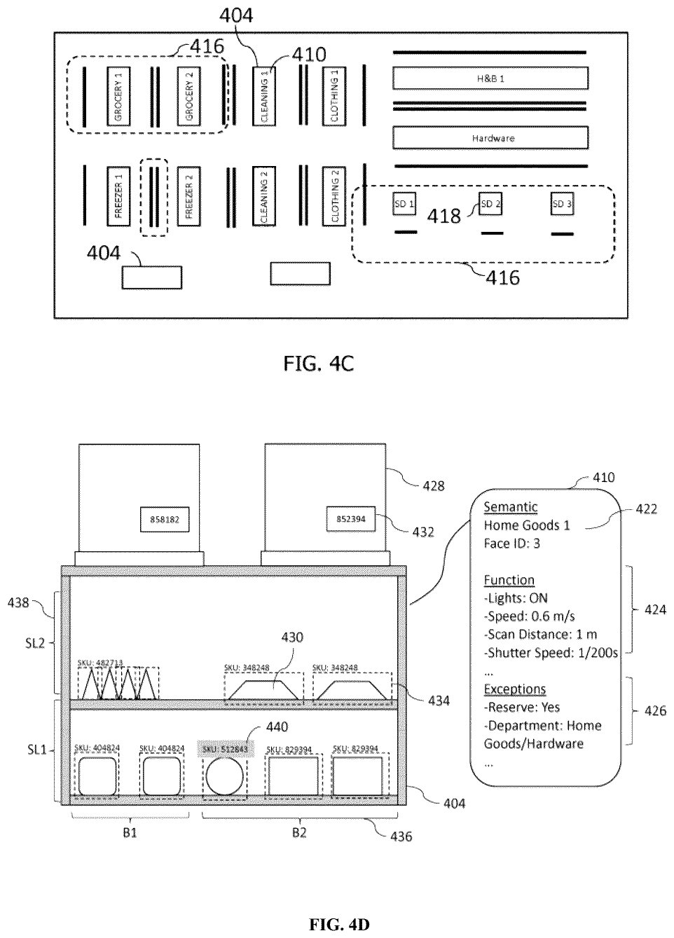

FIG. 4A-C depict a process for generating an annotated map for a robot 102 to utilize during navigation to aid in or enable its task performance, according to an exemplary embodiment. In the present embodiment, the robot 102 is being enabled to image and scan for features within the environment, however, one skilled in the art may appreciate that an annotated map may further enable or enhance other tasks (e.g., delivery services with annotated pick-up/drop-off points). Various steps described herein are performed by either a robot 102 or server 202, however one skilled in the art may appreciate that, in some embodiments, the robot 102 may perform any or all of the tasks performed by the server 202 provided the robot 102 and/or controller 118 comprises sufficient computational recourses to do so. That is, it may be preferred to off-load some computational tasks from the robot 102 onto a server 202 to not overburden the robot 102 during navigation, provided the additional transmission latency and cost are considered.

First, in FIG. 4A, a robot 102 navigates a route 402 within its environment and, using data from sensor units 114, detects a plurality of objects 404 either in whole or in part. Specifically, the surfaces of the objects 404 are sensed, e.g., using LiDAR sensors. The route 402 shown is an exemplary route which causes the robot 102 to detect, at least in part, all the objects 404 to be scanned for features. One exemplary position 406 of the robot 102 is shown with a plurality of view lines 408 which localize nearby objects, wherein only a portion of the nearby objects are sensed by the sensor units 114. While it may be preferable to fully localize and scan each and every object 404 in the environment, this may take a substantial amount of time and effort, wherein the following annotations may be provided without fully localizing an entire object.

Next, in FIG. 4B, the map 400 produced by the robot 102 in FIG. 4A is annotated, according to the exemplary embodiment. Annotations 410, herein, correspond to labels applied to regions on the map 400. These labels may include, in part, semantic labels such as, e.g., “clothing 1” or “grocery 2” corresponding to a cleaning and grocery display, respectively, within a store. The labels may further specify functions or parameters of the robot 102, such as a maximum speed. The specific components and parameters of these annotations 410 are further shown and described in FIG. 4D below. In summary, the annotations enable organization of detected features by assigning the features detected to an object which is labeled in a human-readable manner and further specify the parameters and behaviors of the robot 102.

Annotations 410 may further correspond to an area on the map. For the purpose of scanning for features, the area on the map corresponds to objects to be scanned such as shelves, displays, pallets, and the like. For other purposes, the annotations may denote tasks to perform, services to render, or other instructions (e.g., power down when here, pick up load here, etc.). In some embodiments, objects 404, which have continuous and closed surfaces, are automatically assigned an area corresponding to the area encompassed by the closed surface. In some embodiments, a human user may indicate the area to be annotated. For instance, a user may select two corners 412 of a bounding box (e.g., two clicks, a click and drag, touchscreen tap(s), etc.) which denotes the area of the annotation 410. Thereafter, in either the manual area entry or automatic area detection embodiments, a dialogue box 415 or other form of user input may be provided to the user, enabling them to provide a semantic label to the area, e.g., “cleaning 2.” The user may further specify functionality and exception requirements of the annotation 410, as further described in FIG. 4D below. Since the user specifies the area of the annotations 410, it is not required for the robot 102 to have mapped the entirety of the objects 404, but it is preferred that at least a portion of the objects 404 are mapped to provide the annotator with reference points when drawing the areas.

In the exemplary non-limiting embodiment where the robot 102 is utilizing the map 400 for feature scanning, the robot 102 shown in FIG. 1C above may be required to navigate parallel to the annotated objects 404 to capture consistent and high-quality images of the annotated objects 404. Based on the cameras used, at least the speed of robot 102 and its distance to the imaged subject must be controlled to minimize blur and ensure the images are in focus. Accordingly, each scannable face or side of the annotated objects 404 is assigned a corresponding scanning segment 414 for the robot 102 to follow which configures the images, based on the camera properties, to be in focus. It is appreciated that not all sides or faces of an annotated object 404 contain features to be scanned for, wherein the user may further indicate which face(s) are to be scanned or not. The indicated faces to be scanned may automatically generate a corresponding scanning segment 414 based on robot 102 and environmental parameters (further discussed in FIG. 4C). In order for the robot 102 to have scanned, for example, “grocery 1” the robot 102 will navigate along the two scanning segments 414 on both the left and right side of “grocery 1”.

By defining the area of each scannable object via the corners 412, or other user input, the user has effectively defined a shape. Typically, the shape comprises one of a rectangle or circle, however other shapes are considered. These shapes may further include one or more scannable sides, or faces as used herein. Faces refer to the external edges, perimeter, or sides of an annotated object which a robot 102 should scan for features, wherein each scannable face corresponds to a scanning segment 414. Scannable faces are further assigned an identifier, referred to herein as a “face ID”, which is primarily used for organizational purposes (e.g., to report that ‘product A’ was found in ‘freezer l’ on ‘face 2’). Rectangular objects would, at maximum, contain four scannable faces, however in some instances the objects may have fewer (e.g., a shelf up against a wall would only have one to three scannable faces). For circular or rounded objects, a user may specify how much of the circumference should be scanned via user input, e.g., by specifying (e.g., via clicks of a mouse) two points on a circle/rounded object which define a scannable arc. In some embodiments, the user may be provided with a free-hand drawing tool or other drawing software which enables the provision of custom shapes for the objects to be scanned. The drawing tool may further receive input by the user specifying portions of the shape perimeter (i.e., the outer face of the custom shape) as scannable or not scannable, wherein scanning segments 414 can be generated which correspond to the scannable portions.

In other embodiments, the annotations may further specify robotic behaviors in a similar manner as scanning segments 414 define the path traveled by the robot 102 during scanning. For example, a first area may comprise a carpet floor which should be vacuumed and not be scrubbed by a floor cleaner, whereas another area may comprise a tile floor which should be scrubbed and not vacuumed. In this embodiment, the annotations 410 are provided to floor regions of interest to be cleaned as opposed to objects 404 to be scanned for features of interest. Annotations may also be provided to, for example and without limitation, charging docks, wherein functionality requirements may specify how to approach and leave the charging dock. In another example, a robot 102 may be a robotic waiter in a restaurant which navigates from a kitchen to specified tables with food based on those tables being annotated on a map (e.g., with table numbers), wherein these annotations may specify how to approach the table (e.g., speed and distance) and that its payload should be removed at the table. Other embodiments and uses of annotated maps as described herein are readily envisioned by those skilled in the art are also considered without limitation.

In addition to the annotations 410 provided to the map 400 in FIG. 4B, additional high-level annotations 416 may be provided to the map 400 in FIG. 4C, according to an exemplary embodiment. These high-level annotations 416 further configure the robot 102 to perform certain tasks when entering regions provided with one or more high-level annotations 416. These tasks are typically separate from primary tasks for the robot 102, typically do not impact task performances, and thus can be run concurrently with primary tasks (e.g., cleaning, delivering, scanning, etc.). Examples of high-level annotation 416 tasks may include: displaying a specified message or media, emitting a sound, modifying speed limits, and/or changing expressions (e.g., some robots may display eyes or other emotional expressions to nearby humans). These high-level tasks may be performed without impacting, for example, navigation, feature scanning/imaging, floor care, item transport, or other primary robotic tasks.

To illustrate further, the fully annotated map 400 depicts a supermarket which includes three seasonal displays (“SD”) 418 located near the front of the store located in the bottom right of the map. The three seasonal displays 418 are provided with annotations 410 in a similar manner as the other objects 404, wherein only one side is assigned as scannable as shown by the scanning segments 414. Although noted as “seasonal” these displays may be illustrative of any transient display, promotion, product storage, or sale in a store without limitation. These three seasonal displays 418 often rotate stock based on promotions, seasons, holidays, or other events, wherein a store owner may desire to promote or otherwise theme the environment in accordance with these seasonal displays 418 using, in part, robot 102 and high-level annotations 416.

As mentioned above, these high-level annotations 416 do not impact the ability of the robot 102 to perform its primary tasks. For example, upon the robot 102 entering the region 416 corresponding to the three seasonal displays, the robot 102 may emit sounds or display media. The store owner may configure the region with high level annotations 416 in accordance with the display media desired by the robot 102 and in accordance with the environment. For instance, the owner may desire to play the national anthem on July 4^{th} when the robot 102 enters near the July 4^{th} seasonal displays 418. Alternatively, if the robot 102 includes a screen, projector, or other means of displaying images, sounds, or video, the robot 102 may project/display patriotic images of eagles, flags, fireworks, and the like in keeping with the July 4^{th} theme of the seasonal displays 418. It is appreciated that July 4^{th} is merely an exemplary event, wherein a user may configure the region 416 in accordance with any event they so desire, provided the robot 102 has the capabilities of providing the requested media. Another common example event may include, without limitation, birthdays, wherein the robot 102 displays “Happy birthday Tom” on a user interface when near “Table 4”, determined via an annotated map, in a restaurant where a customer, Tom, is eating or “Tom's desk” (annotated region) in an office space.

In certain embodiments, robots 102 are anthropomorphized with digital eyes, arms, or other human features which allow the robot to express to nearby humans simple emotions, such as frustration when the path is blocked, happiness when the task is complete, focus when performing tasks, and so forth. These are commonly used to communicate to nearby humans what they should expect the behavior of the robot 102 to be, wherein seeing a pair of angry eyes in a blocked supermarket aisle would readily connotate the robot 102 is unable to do what it is assigned to do and/or that the robot 102 should not be bothered. In these instances, the expressions do not impact task performance but are communicative of the state of the task being performed and may accordingly be modified using these high-level annotations 416. For example, a special joyful emotive display may be shown only when robot 102 navigates near a region 416 which has been annotated to indicate it is someone's birthday.

Another primary use case for these high-level annotated regions 416, in addition to thematically enhancing environments with robots 102 for human enjoyment, is to promote certain products or services. For example, in FIG. 4C in between the “freezer 1” and “freezer 2” annotated objects 404 is a high-level annotation 416. The store owner may assign this region 416 onto the map 400 to cause the robot 102 to advertise a sale of a certain frozen product or new products in stock. Accordingly, whenever the robot 102 navigates into the region 416, e.g., to scan the two freezer objects for features (or clean floors, or any other task), the robot 102 will further perform a visual display, auditory display, or both which indicates the sale/promotion that is occurring. Targeted marketing today, especially for digital mediums, is commonplace if not the norm, wherein targeted marketing typically involves a collection of prior searches/interests to generate future purchase predictions tailored to the user based on their specific search history. This practice, however, is largely speculative and generally inaccurate, and is typically employed on broader scales rather than on an individual customers basis at a given brick and mortar store/building. Advantageously, using robots 102 physically present in the location enhances targeted advertising to not only people who are highly likely to buy, e.g., frozen products when they are in the freezer aisles, but also can directly highlight physical products within close range of the humans in this aisle, simplifying their decision making and encouraging purchases. The same may apply to seasonal displays and thematic enhancements of the environment.

FIG. 4D breaks down the annotations 410 provided to an annotated object 404, according to an exemplary embodiment. For the sake of illustration, the object 404 is a home goods display, however it is appreciated that the type of goods displayed is arbitrary and non-limiting. The user provided annotation 410 first comprises a semantic label 422 which labels the object 404 as “Home Goods 1” based on a choice by the user, which, preferably, is readily understood by a human to correspond to a location of the environment. The semantic label further includes the face ID of, for example, three (3), indicating that it is the third face (or, as seen by a customer, the shelf) of the “home goods” object 406, specifically in the first annotated home goods object 406.

The functional annotation aspect 424 defines robotic behaviors in imaging the object 404 to obtain the highest quality images. These parameters may be pre-determined based on the hardware configuration of the robot 102 (e.g., camera properties, speed, size, etc.). For instance, the state of any lights may be defined as “ON” or “OFF”, the maximum speed set, the scan distance determined, and various camera properties such as shutter speed, exposure time, focal length, and the like are configured. In some embodiments, these parameters may be pre-defined based on the intrinsic properties of the cameras 304, 310 and some may not be changeable (e.g., cannot set maximum speed past safe limits). In some embodiments, these parameters can be uniquely defined for each annotation 410. In either case, if an adjustment to one or more of these functional parameters needs to be made to improve image quality, the user may adjust the functional aspect 424 of the annotation 410. Preferably, such functional aspect 424 may be experimentally determined to yield the highest quality images, which may require a skilled operator or the original equipment manufacturer of the robot 102 to perform such experiments to determine optimal scanning parameters for their specific cameras.

Lastly, the exceptions aspect 426 defines various parameters used for exception detection. Exceptions will be discussed in more detail below, but, in short, an exception corresponds to an outlier in data which may require further analysis. In other words, exceptions indicate when a feature is detected in the wrong place (or missing entirely), at the wrong time, and/or any otherwise notable scenario involving a feature detected at a location, wherein a notable scenario could be determined by a human user. For instance, the exception aspect 426 includes a “Reserve storage” yes or no binary question. Reserve storage, as used herein, contain bulk pallets or other large quantities of items typically not available directly to consumers and stored away from reach (e.g., on upper shelves or in predetermined storage spaces). Reserve pallets or bulk containers of items are indicated with an SKU that denotes the items as part of a reserve storage and not for direct sale, wherein the SKU may be affixed via a barcode or alphanumeric code on the external faces of the pallets/bundle which allows for identification of the object as a reserve pallet. If a robot 102 detects a reserve pallet 428 at a location where this parameter is “NO”, an exception is reported as this would indicate a reserve pallet (or other bulk container) 428 is located where no reserve storage is or should be present (e.g., false detection or misplaced pallet 428). In the inverse case, where the robot 102 detects no pallets 428 where the reserve parameter is “YES”, such lack of detection may indicate zero or low stock of a product which may also be denoted as an exception to be recorded and reported. reserve pallets 428 can be detected as distinct from other items 430 for sale based on (i) being imaged by a reserve camera 310, and (ii) a SKU label 432 affixed to the outside of the pallet, wherein the SKU corresponds to a pallet or other storage of product. In some embodiments, computer vision methods may also be utilized to identify and distinguish reserve pallets 428 from other objects.

Annotators may, in some instances, create custom functional and exceptional sections in accordance with their use case and environment type. For instance, some environments may comprise reserve storage above a freezer object 404, wherein a pre-set configuration comprising a YES to “freezer” and “reserve” could be created for a first object 404, saved, and later applied to other objects 404. Such annotation will cause the robot 102 to disable lights when imaging the freezer doors and enable an upper reserve steel camera 310 to capture images. Another example of exceptions could include incompatible features and locations. For example, the exceptions 426 may indicate one or more faces of an annotated object 404 is a freezer, wherein detecting non-frozen products in the freezer would generate an exception to be reported. Similarly, detecting frozen products improperly stored in non-freezer locations could also be configured to generate exceptions in the same manner. Customized exceptions may be created by (i) specifying the parameters of the exception, such as location (e.g., freezer, reserve, etc.), timeframe, and/or other conditions; and (ii) for each product to be identified, specifying the corresponding location, timeframe, and/or other conditions where it should properly be stored/seen (e.g., as specified in a product catalog or inventory database). Detecting the feature at/on a scannable object (i.e., one with a defined location, time, and/or other user conditions specified) with different exceptions 426 from those specified in the exceptions 426 associated with the feature itself automatically generates an exception to report. For instance, a bag of frozen peas may be specified as a “FREEZER” item, wherein detecting the peas on an annotated object 404 that does not contain the “FREEZER” exception 426 condition would generate a misplaced item exception in the final inventory report. Thus, annotations 410 may be applied to physical locations in an environment of the robot 102, and are further specified based on characteristics of the objects in the environment for organizational purposes (e.g., identifying freezer items that should be placed in a freezer, or vice versa).

When capturing an image of the scene as shown in FIG. 4D, the robot 102 may not immediately identify all the SKUs for the items 430 present, rather instead the image is saved and can be processed later. It is appreciated that robots 102 may comprise limited computational bandwidth and may not be able to simultaneously navigate and identify the objects, especially when there are a large number of objects to be identified. In such embodiments, it is preferred to perform image analytics separate from the robot 102 or while the robot 102 is idle. Accordingly, the images may be saved in memory 120 and/or communicated to a server 202 for processing via a continuous data stream or scheduled batched upload. In some alternative embodiments, the images may be saved and will be processed via controller 118 once the robot 102 has completed its tasks.

In performing the analytics, the server 202 may provide the image to one or more models. Such models may be derived from, for example, neural networks as described for FIG. 3 above. The models may also be derived from other sources such as, for example, comparing the features 430 of the image to a reference database (e.g., a catalog of inventory for a store, point of sale data, etc.) for similarity. The models may return bounding boxes 434 which encompass the pixels of identified features 430, wherein each bounding box 434 is encoded with a label corresponding to the SKU of the items 430 as shown in the model. The image shown with the corresponding SKU labels 434 can be a portion of a report or inventory report provided to an end consumer.

When the images are analyzed for features, such as the SKU for each item 430, the annotations 410 provided are utilized to identify exceptions. For instance, if any of the function aspects 424 were not followed by the robot 102, such as the robot 102 navigating too close, too fast, or deviating from the scanning segment 414, the entire image can be denoted as an exception as the image contains low-quality data. Such exceptions may cause the robot 102 to re-scan these object faces. As another example, the exceptions aspect 426 can be utilized. The reserve section is “YES” and reserve pallets 428 are present in the illustrated scenario, thus no exception is generated for the two reserve pallets 428. However, one label 440 (grey highlight) is denoted as an exception based on, e.g., the SKU number which does not match the department as denoted in a store catalog or other database that defines the proper display sections for each SKU. For example, SKU “512843” may correspond to watermelons, which would not be denoted within the department of “home goods” or “hardware” in the store catalog and can thus be noted as an exception caused by, e.g., incorrect model predictions (i.e., object 440 is not a watermelon) or a misplaced watermelon in the environment. Alternative reasons for the SKU 422 generating exceptions may also include, without limitation, the SKU “512843” being invalid (i.e., does not correspond to a stocked product), the SKU missing a digit or including extra ones, or the SKU not matching what other feature identification models predict the feature to be based on the catalog and/or from reading adjacent price labels.

The faces of annotated objects 414 can, in some instances, be further discretized into shelf and bin levels. Shelf levels 438 refer to the vertical height above a floor upon which items should be placed. Shelf levels 1 and 2, referred to as SL1 and SL2, are shown corresponding to the first and second shelves above the floor. Shelf levels do not encompass reserve storage above the display in this embodiment but may in other scenarios. Similarly, bin level 436 discretization involves discretizing the face horizontally. The illustrated display contains two bins 436, B1 and B2, though other displays may contain more or fewer bins. Bins and shelve levels are utilized in an inventory report as a method of organizing the detected features and reporting product locations precisely. The inventory report may contain a reporting of the detected features sensed by the robot and the corresponding locations of those features, or places where expected features are missing due to, e.g., being out of stock. Bins may be named alphanumerically, e.g., B1 and B2 as shown, or may be provided with human readable names, such as “wrenches” and “hammers” bins within a face of a “hardware” object 404. Bins serve a similar organizational purpose as the shelf levels 438. For example, the inventory report may specify that the object 430, SKU 348248, was detected on object 404 (annotated) at shelf level 2 in bin 2. The annotator may provide the vertical and/or horizontal dimensions of the shelf/bin level annotations in a similar manner as the object 404 level annotations, wherein the user selects the bounds via inputs 412.

Although the bin and shelf levels shown in FIG. 4D do not include semantic labels, in some embodiments semantic labels may be applied to the bin and/or shelf levels. Semantic labels may further aid in the specificity of the inventory report and allow human readers thereof to understand intuitively where each bin is in an environment. Exemplary semantic labels for bins may include, without limitation, “toothpaste/dental”, “disposable paper products”, and “shampoo/conditioner” being within an object 404 annotated with “health and beauty” containing a plurality of cosmetic and toiletry products. Other examples of bin sematic labels may be based upon, without limitation, brand names rather than any type of product, which may be preferable depending on the layout of the environment.

In some embodiments, object 404 may encompass a plurality of individual, adjacent shelves or displays separated by bars, edges, signage, or other detectable features which may denote the beginning and/or ends of a display. These separated displays may, if so desired, be automatically assigned a bin whenever such dividers, edges, etc. are detected. It is appreciated, however, that bin and shelf level discretization is largely used for human organizational purposes and does not impact the identification of the features themselves, wherein automatic bin assignments should still preferably be verified to suit the needs of the particular environment and users.

The inventory report may comprise a tabulated list of items 430 detected, their corresponding SKU, and the location, wherein the location may correspond to the semantic label 422 (i.e., “home goods 1”), a robot 102 location where the image was taken (e.g., in x, y coordinates or on a rendering of a map), department (i.e., “home goods”), a shelf location (e.g., in terms of bin and/or shelf levels or horizontal and vertical position), and/or an image-space location (i.e., bounding box 434 location). The location may further include, in some embodiments, a bin identifier corresponding to a sub-section of an annotated object 404 (e.g., “screwdrivers” bin of the “home goods 1” face ID) and/or a shelf level. The report may further denote some detected exceptions, such as misplaced items, planogram noncompliance, price tag mismatches, and/or low or out of stock items.

The parameters and settings for user provided annotations shown and described in FIG. 4D may be provided to a server 202 and/or robot 102 via a user interface, such as user interface units 112 of the robot 102, screen 138, and/or a device 208 such as a personal computer. The interface is configured to receive user input to identify the area occupied by scannable objects (e.g., corners 412 of the bounding box shown in FIG. 4B). For each annotation, the interface is configured to receive further input specifying which face(s) are to be scanned such that corresponding scanning segments 414 are generated. For each scannable face, the user may further input the semantic label 422, functional parameters 424, and/or exception information 426 as appropriate. Lastly, bin and shelf levels may be specified if so desired. The features to be scanned may also have similar information encoded in a database, such as an inventory database or product catalog. Upon identifying a feature, such as with a SKU, the SKU can be searched in the database or catalog for any exception information, such as being improperly stored in the wrong department or being low/out of stock.

Although the annotations shown and described herein relate primarily to retail and warehouse environments with shelves and aisles, one of ordinary skill in the art will appreciate that annotated maps are also frequently used in other environments. For example, home cleaning robots may generate a map of the interior of a home. The map may be displayed on a user interface of a robot 102 or on another device (e.g., smartphone application) coupled to the robot 102 allowing a user to provide annotations 410 to various objects 404 or locations, such as “kitchen”, “dining room”, “living room”, etc. on the map. Such semantic labels enable the user to issue tasks such as commanding the cleaning robot to navigate to “the kitchen” by selecting the annotated kitchen portion of the map. The user may further decide to annotate specific portions of the kitchen, similar to shelf or bin-level annotations, such as the “cooking area”, “dining table” (underneath), “sink”, etc. to further add granularity in where the robot 102 is commanded to perform tasks.

Returning to FIG. 4C, the high-level annotations 416 are provided in a similar manner as the annotations to the objects 404. That is, a user specifies the area encompassed by the high-level annotation 416 in the same or similar manner. Thereafter, the user may assign a semantic label 422 and functional requirements 424 as shown in FIG. 4D via a user interface. Exception 426 information is generally not applicable for the high-level tasks as exception information is primarily used for the feature scanning tasks, but may be applicable for other tasks. For example, the high-level annotation 416 may correspond to a security zone wherein detecting objects or people therein would cause the robot 10 2 to emit an alarm (or, in some cases, a more polite “please leave the area” media) or notify a separate device of the presence of the unauthorized object/person. The functional requirements 424 for high-level annotations 416 are preferably limited to multimedia displays, such as sounds, lights, and/or images/video as these will not impact robotic task performance. Advantageously, these multimedia displays can be tailored to not only the specific environment, but specific parts of the environment. These displays may enhance a thematic design of the environment and/or may provide location based targeted advertisements which improve customer satisfaction and sales.

In some embodiments, the functional requirements 424 may specify a speed limit or modify a minimum distance to objects, wherein a user may provide the high-level annotation 416 to a region which limits the speed of the robot 102 and allows it to drive closer to people and other objects and features in the environment when the environment is crowded with people.

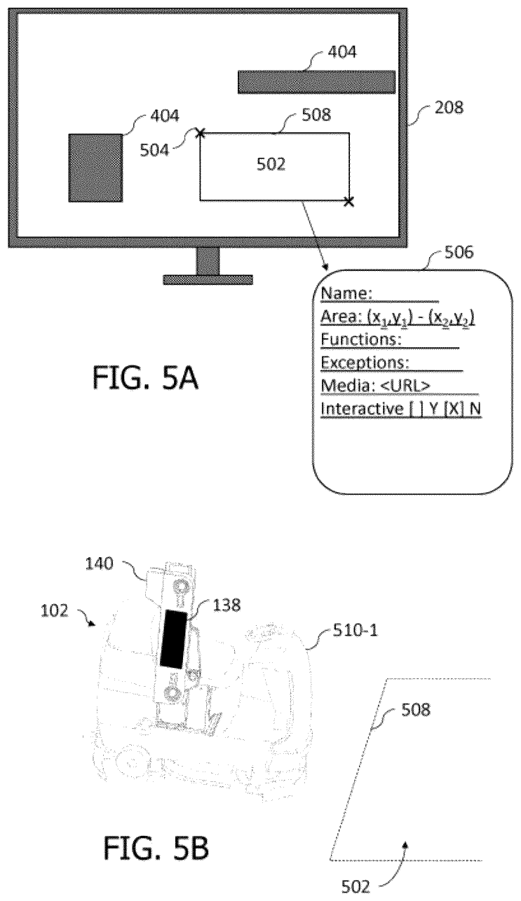

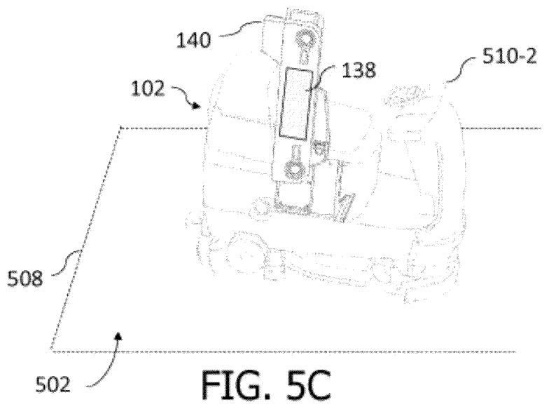

FIG. 5A-C depicts a robot 102 entering a region comprising a high-level annotation 416 and performing an audio-visual display, according to an exemplary embodiment. First, in FIG. 5A, a user highlights a region 502 and provides inputs 504 in a similar manner to the annotation parameters described in FIGS. 4B and 4C above (i.e., the bounding box defined by corners 412). For instance, the person providing the annotations 410 may be provided with a user interface on a device 208 coupled to a server 202 or on a user interface unit 112 of a robot 102. The user interface may display a computer readable map of the environment produced by the robot 102 using data from its sensor units 112 after at least one navigation within the environment or being provided the computer readable map from another source (e.g., via download from a server or another robot 102). In some instances, the computer readable map may be produced by combining multiple maps from one or more robots 102, wherein the server 202 may combine the maps to generate a single large map of the environment (e.g., as shown in FIG. 4B). A portion of such map is illustrated in FIG. 5A, wherein only some objects 404 are shown for clarity.

Using this computer readable map enables the annotator to select, via e.g., inputs 504, regions on the map to annotate. Input 504 may represent two mouse clicks, a click/tap and drag motion, and/or any other form of defining a rectangle. In other embodiments, the inputs 504 can be substituted using drawing tools, such as pre-set shapes or free-hand drawing tools (provided the shape has a continuous and closed perimeter) which may enable more customization of the shape of the region 502, but at the same time may require the annotator to be more skilled in robot management and control than pre-set shapes.

Next, the region or area encompassed by the high-level annotation 416 is defined. In some cases, the corner points 504 locations could define the region as a rectangle. In other embodiments, functions or other pixel-wise definitions of the regions may be implemented. By defining the corner points 504, the perimeter or boundary 508 of the high level annotated region 502 is defined. Once the location, size, and shape of the region 502 is defined, the user may be provided with a dialogue box 506 which is illustrative of the user interface used to define the parameters of the high-level annotation 416. That is, the dialogue box 506 is illustrative of any user interface without limitation configured to receive the parameters disclosed herein. The dialogue box 506 would be displayed on the device 208 screen, but is shown separately in the illustration for clarity. A first parameter may be a “name” which is similar to the semantic labels 422 shown in FIG. 4D above. The name provides a human-readable descriptor of the annotated region, though there is no requirement it be human readable. Although shown in the dialogue box 506, the user interface displaying the region visually on the computer readable map may suffice for most applications, wherein displaying the particular coordinates confers minimal added utility.

In addition to the functional aspects 424 and, in some embodiments, exception information (left blank for clarity), the dialogue box 506 further includes a media argument which allows the user to upload one or more multimedia files, such as an image, audio file, video, or interactive application in any appropriate format. The file may exist on the device 208 being used to provide the annotation 416 or may be uploaded to the robot 102 memory 120 via, e.g., wireless download (e.g., via webhook) or wired download (e.g., from a personal computer, USB drive, etc.). The media file(s) should be executable by the robot 102, wherein a robot 102 which lacks a screen should not be provided with a video file. Lastly, the dialogue box 506 includes a binary prompt to indicate if the media is interactive. Interactive media is discussed further below, but in short, interactive media involves a user input or output beyond merely displaying audio/visual displays. Accordingly, the controller 118 is made aware that the media application could interrupt other tasks.

According to at least one non-limiting exemplary embodiment, the media file argument is automatically provided by the server 202 based on a schedule and/or request from a device 208, such as an external advertiser. The advertiser may indicate to the server 202 that a specified media file should be played while near designated areas. The server 202 may communicate the media file and annotation data (if the annotation data is not being input on the robot user interface units 112) to the robot 102 which configures the robot 102 to display the media upon entering the annotated region 502. Consider, for example, a store chain comprising multiple individual stores which are all running a seasonal display, sale, or promotion which place various seasonal items in a designated spot, typically in the front of the store but not limited thereto. An advertiser, or whomever desires the media to be displayed (e.g., a store manager or other person with requisite credentials to control the robot 102), may upload the media file to the server 202. Thereafter, the server 202 may distribute the media file to all stores (i.e., select robot networks 210) which contain (i) a robot 102, and (ii) the corresponding high-level annotation on a map used by the robot 102 (e.g., which could be transmitted from the server 202). In these embodiments, pre-set values for the “name” argument would be preferred as the server 202 may readily identify the seasonal display in various stores despite the stores differing in layout. The preset value in this example may be a string of characters, e.g., “Fourth of July” such that all fourth of July displays in all stores share the same identifier which cause the robots 102 to display the same media, e.g., fireworks and the national anthem, to enhance the theme of the seasonal display and attract customers who would otherwise walk past the products.

According to at least one non-limiting exemplary embodiment, the dialogue box 506 may further include a behavior argument is also supplied in the dialogue box 506. The behavior argument should be permissive of other tasks by the robot 102 so as to not prevent the robot 102 from being able to perform other tasks, however the task performance may be modulated. For instance, it may be desirable for the robot 102 to drive slower while next to seasonal displays and displaying multimedia as opposed to driving at a default speed and/or in an empty corridor, wherein the behavior argument may include a speed limit adjuster which does not change the task of navigating to different places, cleaning, delivering items, scanning for features, etc., nor impacts the ability of the robot 102 to be able to perform such tasks, but would modulate the navigation speed of the robot 102. While driving slower increases task performance time, generally slower movement does not impact the overall capabilities of the robot 102 to perform its task (e.g., capture images, clean floors, transport items, etc.). Similarly, the distance to objects the robot 102 is allowed to navigate may also be modulated so as to either give humans personal space or the opposite if the multimedia is, at least in part, interactive.

Media displays or non-interactive media, as used herein, is any visual, audio, and/or physical (e.g., via movement of robotic actuators) display which occurs invariant of user input, excluding user input which causes the machine to be unsafe such as joyriding, theft, physical battery, and the like which would cause the robot to cease operations. Interactive media corresponds to visual, audio, or physical displays which are at least in part responsive to a user input, again excluding inputs which cause the machine to be unsafe. Safety as used herein refers to the risk of human injury as well as risk of damage to the robot 102 and nearby objects.

Interactive multimedia displays are also contemplated for the present disclosure. Consider a robot 102 tasked with cleaning a floor in a store. While under normal operating hours, the store may not be fully navigable nor cleanable without disrupting customers. Use of high-level annotations 416 and interactive multimedia may enhance the utility of the robot 102 beyond its standard tasks. For instance, the annotated regions may correspond to individual aisles or sections to be cleaned, wherein the robot 102 may be directed to specific areas based on dynamic environment conditions as desired by humans using a human-readable format (e.g., clean “grocery aisle 2”).

For example, the feature scanning capabilities described herein enable a server 202 to identify and localize various products, which may be imaged by the robot 102 and/or other robots 102. An annotator may designate the front of the store (defined via inputs 504) as a “greeting area” (which may correspond to the name entry in dialogue box 506), and the media file may comprise of computer code which configures the user interface units 112 to operate as a shopping assistant application. The shopping assistant application may, by default, prompt nearby humans to determine if they need assistance finding a product or contacting store employees (e.g., via a screen, user interface, gestures, sounds, external signage, etc.). A human shopper may utilize the user interface units 112 to input a query, such as requesting the location of a certain product in the environment. The shopping assistant application may subsequently issue a query to the server 202 which localizes the desired product and receive a response signal indicating the location of the product. The application may cause the robot 102 to navigate/lead the human shopper to the desired product, display a location on a rendered map of the environment, or provide general directions such as aisle numbers without leaving the annotated area. As another example, a robotic waiter may utilize interactive media to await new customers at the front of the restaurant (annotated “greeting/reception” region) while displaying a “welcome” media and, upon the new customers indicating the number of people in their party via a user interface (e.g., mobile reservation app, robot user interface units 112, or other point of sale system input), the robot 102 may disable the “welcome” media and navigate to an appropriate table, wherein the tables may be determined to be of appropriate size based on annotations 410 of object 404 (e.g., number of seats may be a “function” argument).

Other interactive media displays compatible with the present disclosure are contemplated by those skilled in the art. Interactive media displays often confer the benefit of being more personalized and tangible, which humans generally appreciate over general advertisements displayed throughout an environment. Interactive displays, however, may require a more skilled technician than, for example, a generalized advertisement for a product being displayed on a screen as the technician should be familiar with the limitations and capabilities of the robot 102.

FIGS. 5B-C depict a robot 102 operating in two different states corresponding to the two locations of the robot 102-1 and 102-2 shown in FIG. 5A, according to an exemplary embodiment. The robot 102 in this embodiment is configured to clean floors via a scrubber, capture images of features via module 140, and display user-configured media via a screen 138 and speakers (not shown). The scrubber may include various electro-mechanical devices that clean a floor beneath the robot 102, such as pads, scrubbing brushes, squeegees, cleaning liquid dispensers, and other devices as described above with reference to FIG. 1C. In some embodiments of robot 102, the scrubber may be instead a vacuum or other floor care device. In some embodiments of robot 102, the robot 102 is only capable of imaging features and does not scrub floors, wherein use of a floor cleaning robot 102 is exemplary and non-limiting.

The module 140 is configured to capture images of objects and features adjacent to the robot 102 as the robot 102 drives along. The module 140 includes two cameras 512 that capture images off of the right-hand side of the robot 102 as it moves, though in other embodiments the left-hand side or both sides (e.g., with a 360° camera or a set of cameras providing images from both sides of the robot 102) may be imaged. The module 140 may include lights that may be modulated based on an environmental situation, as indicated by annotations 410 described in FIG. 4D. For example, the lights may be disabled when imaging freezer/fridge doors to prevent glare and enabled otherwise. Lastly, the module 140 includes a display 138 such as an LED screen. In some embodiments, the screen 138 is a touch screen which can receive user input.

Some embodiments of robot 102 are specially configured to capture images of features rather than couple to a module 140 which expands pre-existing capabilities of, e.g., a cleaning robot into the feature imaging task. It is appreciated, however, that use of a feature imaging module 140 to employ a display 138 is also non-limiting Instead, the use of module 140 with the display 138 illustrates how a pre-existing robot 102 may be reconfigured to be applicable with the present disclosure without diminishing its prior tasks, e.g., cleaning floors.

First, in FIG. 5B, the robot 102 is in position 510-1 shown in FIG. 5A, which is outside of the high-level annotation region 502. A portion of the region 502 perimeter closest to the robot 102 is shown via dashed line 508. Since the robot 102 is entirely outside the perimeter, the display 138 is off or otherwise in a default/idle state. The idle state may, in some instances, contain some media which is played by default when the robot 102 is not in any other high-level annotation zone, such as a generic store or brand name, welcome message, or other default media.

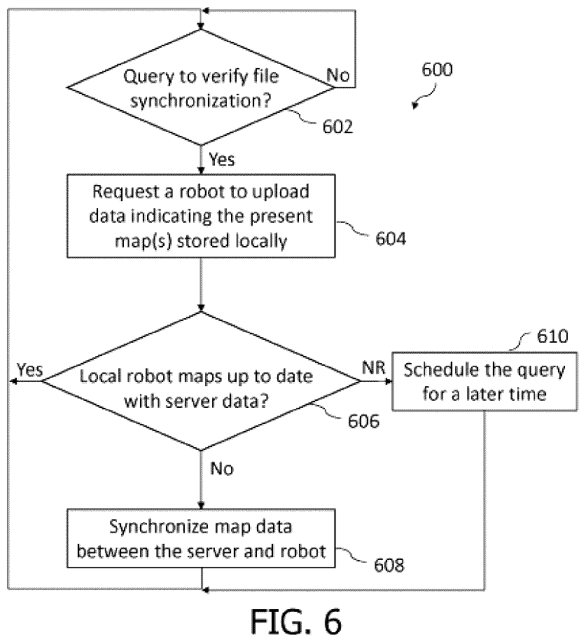

Next, in FIG. 5C, the robot 102 has moved into the high-level annotation region 502. The same portion 508 of the perimeter of the region 502 shown in FIG. 5A is replicated in FIGS. 5B-C. It is appreciated that the portion 508 of the region 502 shown is not a physical line, but rather is representative of digital lines on a map of the environment that corresponds to a physical space. Upon the controller 118 determining that the robot 102 is crossing the boundary 508 of region 502 in part or in whole on its computer readable map, the controller 118 may begin displaying the media corresponding to the region 502, as shown via the display 138 in FIG. 5C. The media file may be downloaded from the server 202 during or after the high-level annotation 502 is provided, or the media file may be directly downloaded via a local connection (e.g., via USB drive or wired transfer). A more detailed discussion on file synchronization between a server 202 and one or more robots 102 is provided in the discussion of FIG. 6 below.

Since the media file is provided by the user and the location of the region 502 is also defined by the user, the present system enables for highly adaptable advertisements and/or thematic enhancements to the environment. These enhancements, while highly customizable, may also be used as templates for other similar environments, wherein the values input into a dialogue box 506 for one robot 102 in a first environment could also be utilized by another robot 102 in another similar environment.

In order to ensure that the customizable high-level annotations are broadly adaptable for use in multiple robots 102 in different locations, it is necessary to ensure proper file synchronization between the robots 102 and a server 202. FIG. 6 is a process flow diagram illustrating a method 600 for one or more processor(s) of a server to ensure proper synchronization of maps, annotations, and media files between one or more robots 102 while enabling user input of the annotations as described herein, according to an exemplary embodiment. It is appreciated that steps performed by the server 202 in method 600 are representative of the steps performed by the one or more processors of the server 202 executing instructions from a non-transitory memory.

First, in block 602, the server 202 awaits a query from a user device 208 or robot 102 to verify file synchronization. File synchronization ensures that a user, via a device 208, is providing annotations 410 to a computer readable map used by a robot 102 is annotating the most up-to-date version of the map. The query may be initiated by the device 208 requesting one or more maps from a robot 102 (which may or may not be stored on the server due to file synchronization) to provide annotations thereon. The query may also be initiated by the robot 102 upon the robot 102 generating new data, such as updated maps or new routes.

Since robots 102 may operate in various environments and are not always powered on, they may not always have continuous connection to the server 202 and may not be available at the moment the device 208 initiates the query to annotate maps. Accordingly, it is important to store the map data on a server 202 such that annotations may be provided when the robot 102 is powered off. To handle non-responding robots 102, the server 202 may contain a list of devices (e.g., powered off robots 102) which are to be queried at set intervals in accordance with method 600, which may be updated and changed in accordance with method 600 and/or other requests by the server 202 (e.g., remote operation). If a robot 102 is powered off during the set intervals, the server 202 may issue the query to the robot 102 until the robot 102 responds. Alternatively, the server 202 may respond directly to a user-inputted query which, in this case, comprises a device 208 requesting to add or edit annotations on a map. If no query to the robot 102 can be made, the server 202 remains in block 602 until one is.

According to at least one non-limiting exemplary embodiment, a robot 102 may initiate file synchronization upon completion of a task or navigation of a route. To initiate the synchronization, the robot 102 may issue a first communications to the server 202 indicating there is data, such as mapping data, stored locally on the robot 102 which needs to be synchronized. Upon receiving such communications, the server 202 moves to block 604 to request the robot 102 upload the new data.

According to at least one non-limiting exemplary embodiment, the query in block 602 is based upon a scheduled time in which verification of the file synchronization occurs (e.g., every 4 hours, at noon, etc.). It may be beneficial to query these robots 102 at scheduled times, e.g., hourly, daily, etc. to ensure the most up-to-date data is available on the server 202 prior to the robot 102 going offline (e.g., powered off and stored away), which may not always occur at predictable times.

Block 604 includes the server 202 requesting the robot 102 upload data indicating the one or more maps presently stored locally on the robot 102. The simplest approach would include the robot 102 uploading all of its map data to the server 202 and the server 202 determining any updates. This methodology, although plausible, comes at incredibly high transmission bandwidth usage, which is especially costly for robots 102 operating on cellular networks. In cases where no updates are made, the uploaded data is effectively redundant use of communications bandwidth. Thus, to minimize unnecessary data transmission between the robot 102 and server 202, the robot 102 and/or server 202 may generate a hash (e.g., via an encryption algorithm) or other form of unique identifier (e.g., a timestamp corresponded to a robot 102 identifier) every time a new map is created, an existing map is deleted, and/or any changes to maps are made locally on the robot 102. Thus, by verifying whether the hash stored in the server 202 corresponds to the value stored on the robot 102, the server 202 may whether verify the map data stored on the robot 102 matches with the map data stored on the server 202 without having to upload the entire map.

Block 606 includes the server 202 verifying the data stored in its memory matches with the map data stored locally in the robot 102, e.g., in memory 120. As discussed above, the robot 102 may receive, via its user interface units 112, various inputs to modify its maps including creating new maps for new routes/tasks, deleting prior maps, or editing existing ones. To identify that a change has been made locally on the robot 102, the server 202 compares the hash value(s) of the map data it received in block 604 to the hash value(s) in the server memory, wherein a discrepancy indicates the server 202 and robot 102 are not synchronized.

In some cases, maps may be edited, deleted, or generated remotely via device 208 through the server 202, wherein the server 202 contains the most up to date map and route information. A user may indicate, via a device 208, to delete a map from use, thereby causing the robot 102 to also delete the corresponding map in its local memory 120. However, the hash value(s) need to synchronize in order to determine the discrepancy between the server 202 data, including the map deletion request, and the local robot 102, which currently stores the map in memory 120.

If the robot 102 does not respond, “NR”, (e.g., if robot 102 is powered off or disconnected from a communication network, such as Wi-Fi/LTE networks), the server 202 moves to block 610.

Upon the server 202 determining a discrepancy exists between the map hashes or metadata stored on the server 202 and those stored locally on the robot 102, the server 202 moves to block 608.

Upon the server 202 determining no discrepancy exists between the map hashes or metadata stored locally on the robot 102 and the map hashes stored on the server 202 memory, the server 202 returns to block 602 and the data is fully synchronized.

Upon the server 202 receiving no response, “NR”, from the robot 102 after a threshold duration, the server 202 moves to block 610.

Block 608 includes the server 202 synchronizing data with the robot 102. Synchronizing data may include the robot 102 uploading one or more maps, edits to existing maps, or indicating one or more deleted maps (i.e., an indication that a map has been deleted from robot memory 120 by a user). Since the metadata and/or hash values for the new data have already been synchronized with the server 202 in block 604, the server 202 may identify which specific elements of data are required. For example, if the robot 102 returns a map hash or other metadata value which indicates a new map was produced locally, the server 202 may receive that new hash, recognize it does not have a corresponding hash in the server memory, and subsequently request the corresponding new map specifically. Similarly, if a new map hash was created on a device 208 coupled to the server 202 to, e.g., provide new annotation data, the server 202 would contain a hash value that the robot 102 does not have. Accordingly, the server 202 transmits the map data and corresponding metadata to the robot(s) 102 indicated by the query.

Block 610 includes the server 202 determining an upload schedule for the robot 102. Block 610 is reached by method 600 when the robot 102 being queried is not reachable, such as when it is powered off or otherwise disconnected from communications networks. The robot 102 is determined to be not reachable when it fails to respond to the interrogatory signal from the server 202 after a threshold duration. The upload schedule in block 610 includes the server 202 issuing the request in block 604 to the robot 102 until the robot 102 has returned a signal. The request may be issued every 10 seconds, 10 minutes, every hour, or other duration until a response is received. By scheduling the request for robots 102 which are offline, the server 202 may continue querying other robots 102 for other functions.

It is appreciated that method 600 may be executed in parallel for multiple robots 102 in various environments, wherein the queried map data would be different for each robot 102. In some cases, the query may simply comprise of a synchronization between the robot 102 and server 202 (i.e., not generating, editing, or deleting map data), which may be scheduled for a plurality of robots 102 in different locations at a set time or interval. In other cases, the query may be more specific, such as particular map edits or annotations performed on a device 208, wherein this query may configure the server 202 to only synchronize the new data to the particular robot 102 of interest. Method 600 may also be executed contemporaneous to method 700 described next.

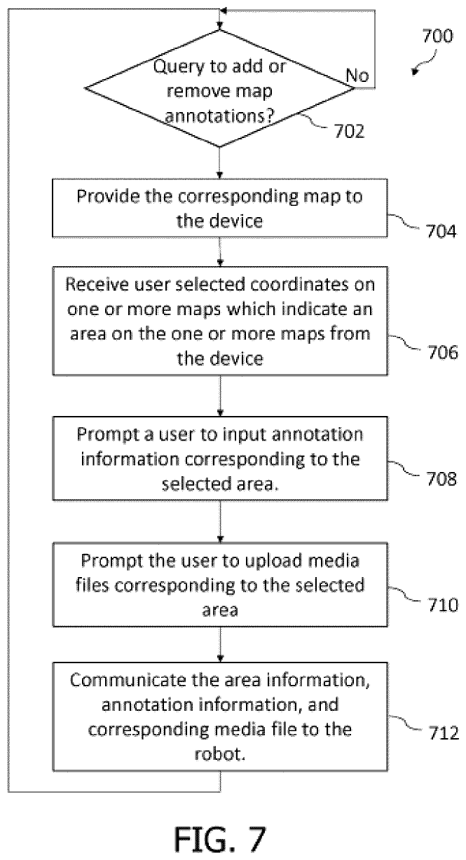

FIG. 7 is a process flow diagram illustrating a method 700 for a server 202 to update and/or synchronize new map annotation data with one or more robots 102, according to an exemplary embodiment. The map annotations described in method 700 will be arriving from a device 208 to a server 202 and communicated to one or more robots 102. It is appreciated that map edits and annotations may be performed on a robot 102 user interface unit 112 without limitation, wherein method 700 would effectively treat the robot 102 as the device 208 described herein.

Block 702 beings with the server 202 waiting for a query to add or remove map annotations to an existing map stored in memory of the server 202. Method 600, described above, ensures that the server 202 contains the most up-to-date version of the map for providing annotations or edits to. In some embodiments, when the robot 102 has not yet responded (i.e., block 810) and a query for map edits is made, the user may be warned about the potential version mismatch. Namely, the robot 102 may contain a more up-to-date version of the requested map than the server 202 contains. If the server 202 does not contain the current version of the map, the server 202 may follow method 800 to retrieve it from the robot 102 by generating a query for this map data in block 602. Hereinafter it will be assumed that the server 202 does contain the most up-to-date version of the map in accordance with method 600. The query received by the server 202 may arrive from a device 208 coupled thereto via, e.g., an application or application program interface (“API”). The query may specify one or more robot 102 identifiers and, in some cases, one or more map identifiers corresponding to the one or more maps that will be edited. In some environments, multiple robots 102 may operate in discrete parts, wherein it may be beneficial to query all robots 102 of a single environment to annotate map information for the entire space. If no query is input, the server 202 remains in block 702 and awaits a query for map edits.

Block 704 includes the server 202 providing the device 208 with the map information requested by the query. It is appreciated that, in accordance with method 800, the map information requested by the user may only exist on the robot 102 unless queried by the server 202 for retrieval. More specifically, the server 202 may contain metadata information, such as time stamps, hashes, etc., which indicate the requested map(s) and its version(s) are present on the robot 102 and known of by the server 202, however the map itself (e.g., images, sensor scans, renderings, pixel states, etc.) may only be stored on the robot 102 unless queried by the server 202 in an effort to reduce transmission bandwidth, and therefore cost. Accordingly, the server 202 may update the query schedule to pull the map data from the robot 102 in accordance with method 600.

If the robot 102 does not respond to the request for the map by the server 202, the server 202 may query the response for a later time in accordance with method 600 (i.e., specifically block 610). In some embodiments, the server 202 may also communicate a signal to the device 208 to indicate that the map is not currently available. Some embodiments may allow a user to edit annotation information on outdated maps, whereas others may not due to a risk of the environment substantially changing, which would render the annotation information incorrect, misplaced (e.g., if annotated objects are relocated or rearranged), or outdated, wherein the user being allowed to edit on an old map version may be permissible in some use cases. For example, an office space cleaning robot may not expect the environment to change substantially over a single day, but a warehouse floor might change throughout a single day, and failing to note those changes may pose a large safety risk. In other applications, such as a home robot cleaner where the robot and operator generally exist within the same area, requiring the robot 102 to be powered on while providing annotations to avoid the non-response (“NR”) scenario of block 810 is less of a constraint and could be implemented for these robots as opposed to larger industrial transport robots which are often, at least in part, teleoperated from another location.

Block 706 includes the server 202 receiving user selected coordinates corresponding to locations on the one or more maps that were queried. The user selected coordinates indicate an area on the one or more maps to be annotated in accordance with method 700. The device 208, upon receiving the map information in block 704, may display the map on a user interface and provide the user with various tools to annotate the map. The user may select the coordinates via an interface of the device 208, such as by tapping a touchscreen, clicking a mouse, or some other form of input. In some embodiments, the user interface may provide the annotating user with a set of pre-defined annotation tools to define the area(s) in the manner desired by the user, such as pre-defined shapes (e.g., rectangles and circles) and free-hand drawing tools. The shapes or areas defined by the user inputs should include a closed boundary.

Block 708 includes the server 202 prompting a user to input annotation information corresponding to the area selected in block 704. As shown above in FIG. 4D, the annotation information may be broken down into various aspects. These aspects of the annotation information may include a semantic label, such as “greeting area” or other identifying text. The semantic label does not need to be human-readable (e.g., “annotation 12345” is a valid semantic label), however, configuring them to be human readable may benefit humans organization when reviewing the map later (e.g., to edit the annotation, which may be done by another human user).

Other aspects of the annotation information may include functional aspects, such as speed limits, behaviors, and/or states of robotic actuators. The particular functionalities discussed herein are not intended to be limiting, one skilled in the art may appreciate that the functionality annotation aspect described herein would be applicable to any robotic use case. Consider robot 102 to comprise of an item-transport robot which receives payloads, moves them, and places them at a designated drop-off location. During general autonomous operation, the robot 102 may ignore any new pick-up requests while it is transporting an object, however an annotated region may indicate to the robot that it should stop and either await an unload, additional payload(s), or user instructions to continue. Advantageously, the user-provided annotation may enable adaptable and transient drop-off and pick-up zones.

As another example, a retail environment with customers present may contain a plurality of robots 102 therein. The robots 102 may be, for example, floor care robots, item transport robots, scanning robots, shopping assistant robots, robotic wheelchairs/mobility scooters, and/or other robots 102. A human annotator may desire for a greeting message and/or shopping assistant application to be executed while the robots are at the front of the store, the shopping assistant application would direct shoppers to a product they input via the user interface units 112. The robots 102 should otherwise operate normally in fulfilling their autonomous tasks. Accordingly, the functionality aspect may include at least reducing speed while in the annotated region to provide ample time for the greeting message to play. Unlike a greeting message, which is non-interactive media (i.e., something the robots 102 may do without input from humans), a shopping assistant application is interactive media and would require a human input that would interrupt the normal autonomous tasks. Accordingly, a functionality parameter that enables interruptions of autonomous tasks to execute an interactive media application may be provided as a binary option. If the item is not selected, the robot 102 should not be interrupted by human inputs or media applications in any new way. That is, aside from emergency stops, joyride protections, (near) collisions, and other safety precautions which normally interrupt autonomous navigation (i.e., would stop the robot regardless of the media file), the media application should not interrupt autonomous task performance.

Depending on the environment and safety considerations, one may desire the media file to continue or cease upon the robot 102 experiencing an emergency stop. In some cases, the robot 102 may be prevented from performing its primary autonomous task (e.g., its path is blocked), wherein idling while displaying media may be preferable. In more hazardous situations, it may be beneficial to cease media displays upon the robot 102 encountering a difficult situation, such as mechanical faults or sensor failures, especially for interactive programs which incentivize humans to approach the malfunctioning robot 102. Alternatively, in at least one exemplary embodiment, the high-level annotation may include a media display of a warning or caution notice for a certain area, wherein such warning should persist even if the robot 102 ceases movement. Advantageously, the high-level annotations described herein are highly adaptable to specific environmental conditions at user discretion.

Other functionality aspects described herein may be leveraged for specific autonomous use cases. For example, for scanning retail displays, it may be desirable to modulate lights such that dimly lit displays are illuminated while freezer displays, which are typically behind glass, are not due to glare. Accordingly, the freezer annotated objects may indicate “lights OFF” in their functional annotation aspect. Further, the scanning application may define the distance between the robot 102 and display being scanned such that the images are in focus. As another example, floor care robots may scrub and vacuum some floors (e.g., hard floors) and only vacuum other floors (e.g., carpets), wherein the functionality annotation aspects could be leveraged to define which floor areas are to be scrubbed and vacuumed and which are to only be vacuumed.

Block 710 includes the server 202 prompting the annotating user to input a media file corresponding to the selected area. The media files discussed herein generally fall into one of two categories: interactive and non-interactive. Non-interactive media, as used herein, is any visual, audio, and/or physical (e.g., via movement of robotic actuators) display which occurs invariant of user input, excluding user input which causes the machine to be unsafe such as joyriding, theft, physical battery, and the like. Interactive media corresponds to visual, audio, or physical displays which are at least in part responsive to a user input, again excluding inputs which cause the machine to be unsafe. Safety as used herein refers to the risk of human injury as well as risk of damage to the robot 102 and nearby objects.

Non-interactive media simply requires the robot 102 to display the media when it enters or navigates within the annotated region. The annotation prompt may enable basic functions, such as looping the media or stopping after one execution/playback, volume controls, and the like. For robots 102 with multiple screens or displays, the user may further specify which screens, speakers, and/or displays are to be utilized. The server 202 may contain a list of robot types which are coupled to the server 202 and their general functionalities such that a user does not upload a media file which cannot be displayed by a robot 102 which lacks components capable to executing the media file, e.g., a screen, speaker, or relevant actuators. Since non-interactive media files simply require a compatibility check, which can be performed using tabulated binary values (i.e., has/has no screen, speaker, etc.) for various robot 102 types, non-skilled technicians are enabled to configure their robots 102 to display the media without a deep understanding of the robot features and limitations.

Interactive media, while enabled by this disclosure, may require additional programming skills to configure. It is appreciated that the person performing the annotations does not have to be the same person who configures/programs the interactive media, wherein the media may be provided from an external party who may not have access to map information as this data is often confidential.

Programmers may configure interactive applications on a robotic platform via an application programming interface (“API”) and/or software development kit which provides for an interface between the robot 102 machine and external programmer code. The API ensures that the programmer code is not malicious, cannot access confidential information, and has limited capabilities (e.g., to avoid physically unsafe programs). The API may further clearly define the possible functions of the media, such as in which channels to execute the media (i.e., audio, visual, and/or particular channels thereof), which inputs may be received from a user (e.g., speakers, touch screens, buttons, etc.), the particular actuators that can be manipulated by the media, and other limitations and functionalities available to be manipulated by the interactive media. Advantageously, use of an API ensures that potentially confidential information, such as indoor floorplans sensed by the robots 102, are not shared while still enabling external parties to program interactive media for the robots 102. For instance, a retail store may desire to contract with an external advertising partner to run a transient sale/promotion using, at least in part, interactive media, wherein the store is safe from disclosing confidential information and the programmers are still enabled to configure the interactive media.

Block 712 includes the server 202 synchronizing the map and annotation data received from the device 208 with one or more robots 102. Block 712 may be effectuated via the server 202 executing method 800 by querying the one or more robots 102 to update or add to their locally stored maps with the map file, including the annotation information and media file therein. By doing so, both the server 202 and the one or more robots 102 both include the most up-to-date map file. Further, for robots 102 which are offline or not reachable, the scheduled queries of method 800 would cause the offline robots 102 to download the updated map and annotation information next time the robots 102 power on and connect to the server 202.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation;” the term ‘includes” should be interpreted as “includes but is not limited to;” the term “example” is used to provide exemplary instances of the item in discussion, not an exhaustive or limiting list thereof, and should be interpreted as “example, but without limitation;” adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, +5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A system, comprising:
one or more robots; and
a server coupled to the one or more robots, the server comprising one or more processors configured to execute computer readable instructions to:
receive a first query from a first device coupled to the server, the first query comprises a request for one or more maps from a memory associated with the one or more robots;
provide a respective map of the one or more maps to the first device from the memory associated with the one or more robots;
receive, from the first device, a set of user selected coordinates corresponding to an area on the respective map;
correspond the area with at least one media file via a user input of the media file onto the area;
communicate the respective map, the area on the respective map, and the at least one media file, to the one or more robots, the one or more robots are configured to execute at least a portion one or more of the at least one media files upon entering the area; and
store the respective map, the user selected coordinates on the respective map, and the at least one media files corresponding to the area on the respective map in a different memory.

2. The system of claim 1, wherein the at least one media file comprise an interactive media program configured to prompt the user to provide a user input to the robot and execute a response to the user input received by the robot.

3. The system of claim 2, wherein,
the interactive media program comprises an item finding program,
the user input comprises a selection of one or more items, and
the response to the user input comprises at least one of (i) an indication of a location of the one or more items on the map and (ii) navigating the robot to the location of the one or more items via the map.

4. The system of claim 3, wherein the one or more processors are further configured to execute the computer readable instructions to:
receive a plurality of images from the one or more robots;
identify one or more items within the images; and
localize the one or more items on the respective map based at least in part upon a location of where the images were taken on the map and a location of the one or more items in the plurality of images.

5. The system of claim 4, wherein the one or more processors are further configured to execute the computer readable instructions to:
receive a second query from the device, the second query comprises a request for one or more items selected via the device; and
provide an indication of the location for the selected one or more items via at least one of navigating to the location or displaying the computer readable map with the localization information corresponding to each of the selected one or more items.

6. The system of claim 2, wherein,
the one or more media files executed by the one or more robots comprises at least one of (i) an emission of a sound and (ii) a display of visual media, wherein the navigation by the one or more robots is not modified by the execution of the media file.

7. The system of claim 1, wherein,
the media file is provided by a second device different from the device that provides the user selected coordinates.

8. The system of claim 1, wherein the one or more processors are further configured to execute the computer readable instructions to:
determine that the memory comprises a memory device of a first set of robots, the first set of robots comprising at least one robot;
transmit a signal to the first set of robots, the signal comprising a request for the respective map to be uploaded to the server from the memory device of the first set of robots; and
store the respective map in the second memory device of the server prior to providing the respective map to the first device.

9. A method, comprising:
receiving a first query from a first device coupled to a server, the first query comprising a request for one or more maps from a memory associated with one or more robots;
providing a respective map of the one or more maps to the first device from the memory associated with the one or more robots;
receiving, from the first device, a set of user selected coordinates corresponding to an area on the respective map;
corresponding the area with at least one media file via a user input of the media file onto the area;
communicating the respective map, the area on the respective map, and the at least one media file, to the one or more robots, the one or more robots are configured to execute at least a portion one or more of the at least one media files upon entering the area; and
storing the respective map, the user selected coordinates on the respective map, and the at least one media files corresponding to the area on the map in a different memory.

10. The method of claim 9, wherein the at least one media file comprise an interactive media program configured to prompt the user to provide a user input to the robot and execute a response to the user input received by the robot.

11. The method of claim 10, wherein,
the interactive media program comprises an item finding program,
the user input comprises a selection of one or more items, and
the response to the user input comprises at least one of (i) an indication of a location of the one or more items on the map and (ii) navigating the robot to the location of the one or more items via the map

12. The method of claim 11, further comprising:
receiving a plurality of images from the one or more robots;
identifying one or more items within the images; and
localizing the one or more items on the map based at least in part upon a location of where the images were taken on the respective map and a location of the one or more items the plurality of images.

13. The method of claim 12, further comprising:
receiving a second query from the device, the second query includes a request for one or more items selected via the device or user interface; and
providing an indication of the location for the selected one or more items via at least one of navigating to the location or displaying the computer readable map with the localization information corresponding to each of the selected one or more items.

14. The method of claim 10, wherein,
the one or more media files executed by the one or more robots comprises at least one of (i) an emission of a sound and (ii) a display of visual media, wherein a route navigated by the one or more robots is not modified by the execution of the media file.

15. The method of claim 9, wherein,
the media file is provided by a second device different from the device which provides the user selected coordinates.

16. The method of claim 9, further comprising:
determining the memory comprises a memory device of a first set of robots, the first set of robots comprising at least one robot;
transmitting a signal to the first set of robots, the signal comprising a request for the respective map data to be uploaded to the server from the memory device of the first set of robots; and
storing the respective map in the second server memory prior to providing the respective map to the device.

17. A non-transitory computer readable medium having computer readable instructions stored that when executed by at least one processor configure the at least one processor to:
receive a first query from a first device coupled to a server, the first query comprising a request for one or more maps from a memory associated with one or more robots;
provide a respective map of the one or more maps to the first device from the memory associated with the one or more robots;
receive, from the first device, a set of user selected coordinates corresponding to an area on the respective map;
correspond the area with at least one media file via a user input of the media file onto the area;
communicate the respective map, the area on the respective map, and the at least one media file, to the one or more robots, the one or more robots are configured to execute at least a portion one or more of the at least one media files upon entering the area; and
store the respective map, the user selected coordinates on the respective map, and the at least one media files corresponding to the area on the map in a different memory.
